(19) United States
(12) Patent Application Publication
(10) Pub. No.: US 2024/0398164 A1
(43) Pub. Date: Dec. 5, 2024

(54) Food Preparation Appliance Equipped With Weighing Means

(71) Applicant: SEB S.A., Ecully (FR)

(72) Inventors: Marie Dussart, Ecully Cedex (FR); Romain Turpin, Ecully Cedex (FR)

(73) Assignee: SEB S.A., Ecully (FR)

(21) Appl. No.: 18/688,118

(22) PCT Filed: Aug. 12, 2022
(86) PCT No.: PCT/EP2022/072664

§ 371 Date: Feb. 29, 2024

(30) Foreign Application Priority Data
Sep. 1, 2021 (FR) 2109135

(51) Int. Cl. A47J 36/34; A47J 43/07; G01G 3/14; G01G 21/22; G01G 21/23

(52) U.S. Cl. CPC A47J 36/34; A47J 43/07; G01G 3/14; G01G 21/22; G01G 21/23; A47J 2043/0733

(57) ABSTRACT

A food preparation appliance includes a housing with at least one supporting leg, a work bowl, and weighing means arranged to weigh food to be prepared. At least one supporting leg includes suspension means having a supporting part, an anchoring part, and elastic return means. The suspension means is arranged to allow a displacement of the supporting part, in that the preparation appliance includes abutment means to limit the displacement of the supporting part, and in that the weighing means are attached between the supporting part and the housing.

### TECHNICAL FIELD OF THE INVENTION

The present invention generally relates to a food preparation appliance that comprises a work bowl for food to be prepared and weighing means arranged to weigh the food received in the work bowl.

### STATE OF THE ART

In the prior art of food preparation appliances, a known example is document EP0561259A1, which discloses a food preparation appliance equipped with weighing means in the form of strain gauges bonded to a weighing bar. On the other hand, over time, this system can lead to drifts in the accuracy of weighing measurements, due to an excessive number or extent of deformations caused by the loads placed on the appliance.

### DISCLOSURE OF THE INVENTION

The present invention aims to remedy the aforementioned drawbacks of the prior art and, in particular, firstly, to provide a food preparation appliance equipped with weighing means ensuring reliable and repeatable accuracy of the weighing measurements over time.

For this purpose, a first aspect of the invention relates to a food preparation appliance comprising:
a housing with at least one supporting leg arranged to rest on a work surface,
a work bowl arranged to receive food to be prepared,
weighing means arranged to weigh food to be prepared that is received in the work bowl, characterized:
in that the at least one supporting leg comprises suspension means comprising:
   a supporting part on the work surface,
   an anchoring part connected to a portion attaching the leg of the housing, and
   elastic return means arranged between the supporting part and the anchoring part, the suspension means being arranged to allow a displacement of the supporting part relative to the anchoring part,
in that the preparation appliance comprises abutment means to limit the displacement of the supporting part relative to the anchoring part,
and in that the weighing means are attached between the supporting part and the portion attaching the leg of the housing.

According to the above embodiment, the food preparation appliance comprises, at the supporting leg, means of suspension with an anchoring part that is integral with the housing and a supporting part that is mobile relative to the anchoring part. Abutment means are provided to limit the displacement of the supporting part, and the weighing means are arranged between the supporting part and the attachment of the anchoring part on the housing. Thus, the greater the load applied, the greater the displacement and the more the weighing means are strained. In this embodiment, an overload applied to the housing would normally cause an overload on the weighing means and a deformation going beyond the normal range of use, but the abutment means limit the displacement and therefore preserve the weighing means. In other words, beyond a threshold force applied to the housing, the abutment means come into action to limit the movement and prevent the overload from passing through the weighing means. In this case, the abutment means transmit the overload directly from the housing to the supporting part. In other words, the abutment means, when they limit the displacement of the supporting part due to an overload on the housing, form the transmission chain of the overload to the work surface, and “bypass” the path of the force normally passing through the weighing means when the forces in question are below a threshold force.

According to one embodiment, the supporting part comprises a support pad arranged to rest on the work surface.

According to one embodiment, the anchoring part comprises a fixed frame, recessed on the housing that supports the supporting part according to a connection that leaves at least one degree of clearance between the anchoring part and the supporting part. The connection can be a joint with parts that are movable relative to one another (for example, sliding, pivoting, sliding pivot, ball joint, with or without play, connections that do not fall within the previous definitions but allow displacement relative to the parts). Joints with rigid parts that do not deform or deform only slightly and move relative to one another can be foreseen, but connections with elastic parts that deform, such as leaf springs for example, can also be envisaged.

According to one embodiment, the suspension means are arranged to allow axial displacement of the supporting part relative to the anchoring part in a direction normal to the work surface, the abutment means comprising axial abutment means to limit the axial displacement of the supporting part relative to the anchoring part beyond a first predetermined force, in particular when an overload is applied to the housing or to the work bowl. Axial displacement is typically caused by the application of excessive amounts of food in the work bowl, and/or by vertical pressure generated by a user (to close a lid or to install the work bowl if it is removable, for example). The axial direction in this case is typically vertical or the direction in which the weight is applied.

According to one embodiment, the axial abutment means comprise an abutment part integral with the housing or with the anchoring part, said abutment part being arranged to abut against a portion of the supporting part in order to limit the axial displacement of the supporting part relative to the anchoring part. A surface contact makes it possible to limit the occasional pressures and deformations of the equipment generated by excessive contact pressure.

According to one embodiment, the portion of the supporting part forms a peripheral flange defining a contour of the supporting part on which said abutment part abuts. The abutment is reliable and does not require highly precise surfaces, since the entire perimeter can be used as an abutment.

According to one embodiment, the axial abutment means comprise an abutment part integral with the housing or with the anchoring part, said abutment part being arranged to abut against the work surface in order to limit the axial displacement of the supporting part relative to the anchoring part. The abutment part can come into direct contact with the work surface, which can provide a simple structure.

### According to One Embodiment:

the housing or the anchoring part comprise a footwell forming an at least partial casing for the supporting leg, with a lower end contour forming the axial abutment means. Such a footwell makes it possible to conceal most of the leg, offering an appliance that is beautiful in appearance and easy to maintain.

According to one embodiment, the food preparation appliance comprises secondary axial abutment means comprising:
a secondary leg abutment integral with the supporting part,
a secondary housing abutment integral with the housing,
   the secondary leg abutment being arranged to abut with the secondary housing abutment in order to limit the axial displacement of the supporting part below a second predetermined force, in particular when there is no load applied to the housing or work bowl.

According to one embodiment, the secondary leg abutment comprises a shoulder arranged to interact with a shoulder of the secondary housing abutment. The aforementioned shoulders can extend radially inwards as well as outwards in the case of rotating parts.

According to one embodiment, the suspension means are arranged to allow lateral displacement of the supporting part relative to the anchoring part in a direction lateral or tangential to the work surface, the abutment means comprising lateral abutment means between the supporting leg and the housing to limit the lateral displacement of the supporting part relative to the anchoring part, in particular during a lateral movement of the food preparation appliance on the work surface. Limiting radial, transverse or lateral displacement ensures that there are no overloads or disruptions during lateral displacement (the user sliding the appliance on the work surface) or in the case of preparation with a rotating work tool that generates lateral vibrations due to shifting or imbalance in the rotating masses.

According to one embodiment, the lateral abutment means are arranged on the side wall of the footwell of the housing or of the anchoring part, the supporting part being arranged to abut against said side wall of the footwell in order to limit the lateral displacement of the supporting part relative to the anchoring part. In other words, it is the inner side wall of the footwell (typically in the shape of a tube) that serves as an abutment for the supporting part.

According to one embodiment, the elastic return means comprise a compression spring arranged to exert a predetermined suspension force to push back the supporting part of the anchoring part in a direction normal to the work surface.

According to one embodiment, the anchoring part comprises an axial housing for the compression spring, and the compression spring forms a housing or positioning for an upper part of the supporting part, these elements being arranged to impose a neutral position or equilibrium position on the supporting part relative to the anchoring part, in at least one direction lateral or tangential to the work surface. Centering pins or wells or centering counterbores may be envisaged to receive the compression spring.

According to one embodiment, the compression spring is arranged between the weighing means and the supporting part.

According to one embodiment, the anchoring part comprises at least one weighing bar arranged to be deformed flexurally when a load is applied on the housing or work bowl. Such a weighing bar typically forms a beam with a first end attached to the housing and a second end attached or connected to the supporting part. The weighing bar may comprise a thinned part to promote a local deformability area, where a deformation sensor will be attached, for example.

According to one embodiment, the weighing bar is directly attached to the portion attaching the leg of the housing. It is possible to provide a connection of the recessed type, with a screw attachment.

According to one embodiment, the weighing means comprise at least one strain gauge or strain sensor, or a piezoelectric sensor.

According to one embodiment, the food preparation appliance may comprise working means comprising at least one work tool and a drive motor arranged to move the work tool in the work bowl so as to work the food to be prepared that was received in the work bowl, and/or cooking means arranged to cook or heat the food to be prepared that was received in the work bowl.

According to one embodiment,

### DESCRIPTION OF THE FIGURES

Other features and advantages of the present invention will become more apparent from the following detailed description of an embodiment of the invention, provided by way of non-limiting example and illustrated in the appended figures, in which:

FIG. 1 represents a front view of a food preparation appliance on a work surface, comprising supporting legs with suspension means;

FIG. 2 represents a view from below of the food preparation appliance in FIG. 1;

FIG. 3 represents a cross-sectional view of a supporting leg of the food preparation appliance in FIG. 1;

FIG. 4 represents the supporting leg in FIG. 3, when the food preparation appliance is lifted from the work surface;

FIG. 5 represents the supporting leg in FIG. 3, when the food preparation appliance is resting on the work surface under normal load conditions;

FIG. 6 represents the supporting leg in FIG. 3, when the food preparation appliance is resting on the work surface under excess load conditions;

FIG. 7 represents a supporting leg according to an alternative embodiment of the embodiment in FIG. 3, when the food preparation appliance is lifted from the work surface;

FIG. 8 represents the alternative embodiment of FIG. 7, when the food preparation appliance is resting on the work surface under normal load conditions;

FIG. 9 represents the alternative embodiment of FIG. 7, when the food preparation appliance is resting on the work surface under excess load conditions.

### DETAILED DESCRIPTION OF EMBODIMENT(S)

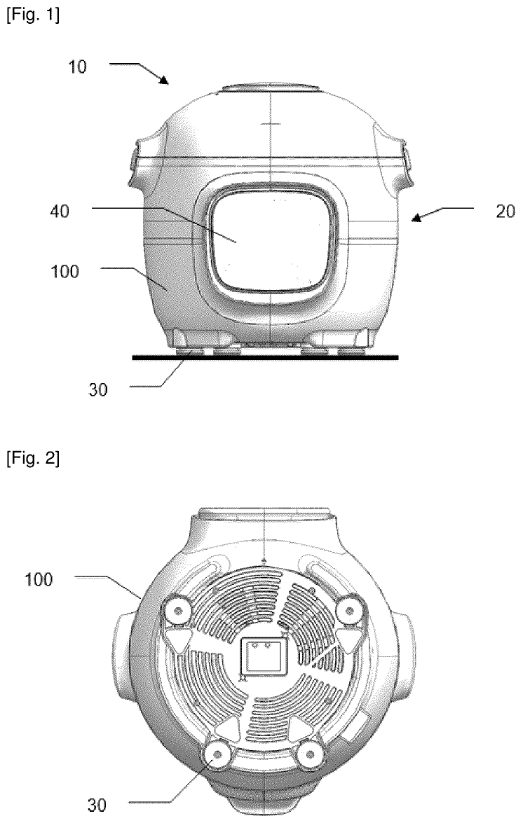

FIG. 1 generally represents a food preparation appliance comprising a base body 20 capped by a lid 10, and resting on a work surface on supporting legs 30. A housing 100 forms the shell of the food preparation appliance and has an outer wall with a display and control screen 40.

The food preparation appliance may comprise a work bowl to receive food to prepare. In some embodiments, working means can be provided, with one or more work tools for performing various operations (kneading, chopping, cutting, mixing, etc.) In some embodiments, heating means can be provided to cook or warm food.

FIG. 2 represents the food preparation appliance in FIG. 1 seen from below, to highlight the four supporting legs 30 distributed under the underside of the housing 100.

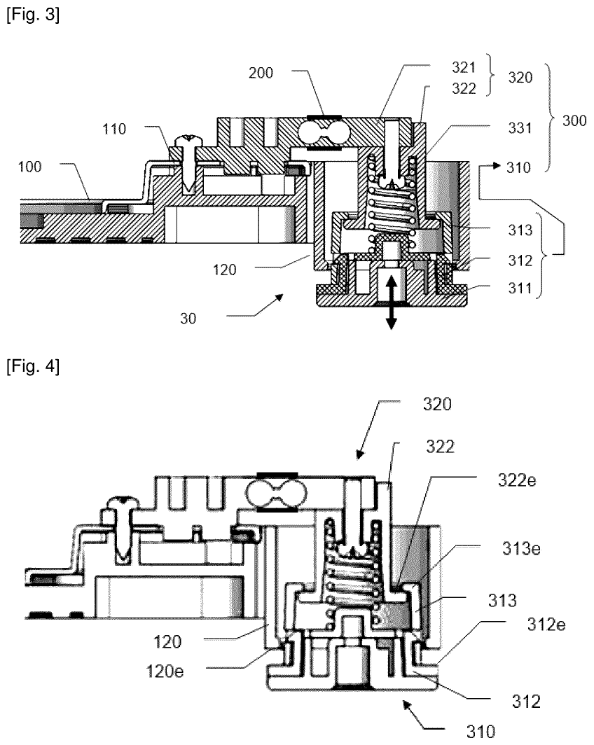

FIG. 3 represents a cross-section of a first embodiment of the supporting legs 30 of the food preparation appliance. In general, the supporting leg 30 comprises suspension means 300 that comprise:
an anchoring part 320 connected and attached to the housing 100, and
a supporting part 310 that is mobile relative to the anchoring part 320 and arranged to be in contact with the work surface,
elastic return means, in this case a compression spring 331.

The housing 100 comprises a footwell 120 which almost completely receives the supporting leg 30, of which only the lower part extends beyond the housing 100.

In detail, the anchoring part 320 comprises:
a weighing bar 321,
an anchor pin 322,
   wherein the weighing bar 321 is attached on the one hand on a leg attachment portion 110 of the housing 100, and on the other hand supports the anchor pin 322. A recessed area is provided approximately in the middle of the weighing bar 321.

The supporting part 310 comprises:
a support pad 311 arranged to contact the work surface,
a strut 312 receiving the support pad 311,
a socket 313 into which the strut 312 is clipped.

The compression spring 331 is inserted between the anchoring part 320 and the supporting part 310, and it is received in an inner circular groove of the anchor pin 322, and on an upper boss of the strut 312.

As will be explained in detail in FIGS. 4 to 6, the supporting part 310 can move relative to the anchoring part 320 and the preparation appliance comprises abutment means to limit the displacement of the supporting part 310 relative to the anchoring part 320 when the load exceeds a predetermined threshold.

In general, the abutment means are provided to limit the displacement of the supporting part 310 relative to the anchoring part 320.

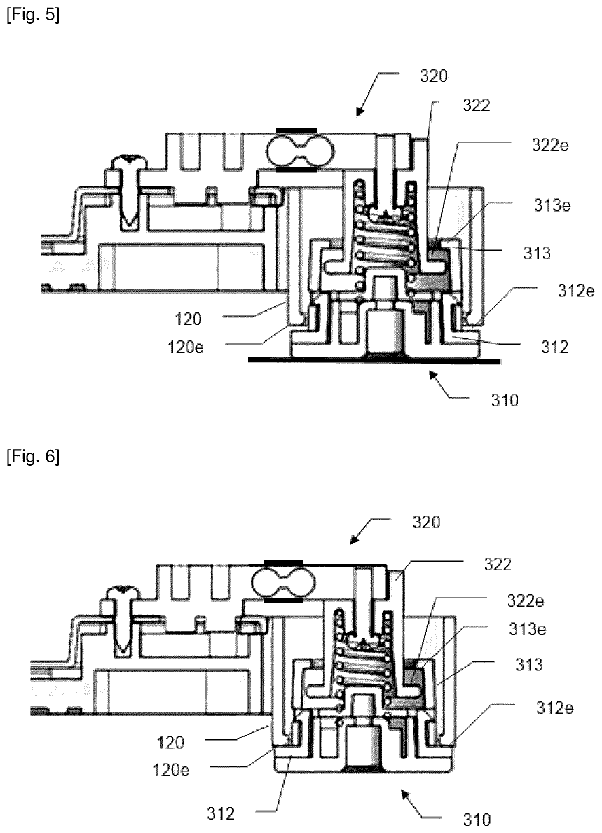

In the event of an axial overload (according to the vertical direction in FIG. 3), the housing 100 abuts against the supporting part 310. In detail, the lower portion of the footwell 120 is arranged to contact the upper shoulder surface of the strut 312. This will be detailed in FIG. 6.

In the event of a lateral overload (according to a horizontal direction in FIG. 3), the housing 100 abuts against the supporting part 310. In detail, an inner surface of the lower portion of the footwell 120 is arranged to contact a lateral surface of the socket 313.

In the event that the appliance is lifted from the work surface, the anchoring part 320 abuts against the supporting part 310. In detail, a radial shoulder of the anchor pin 312 comes into contact with a radial shoulder of the socket 313. This will be detailed in FIG. 4.

Weighing means 200 are also integrated into the supporting leg 30, in this case in the form of strain gauges bonded to the weighing bar 321 at its recessed part to maximize deformations in this area.

As explained above, the preparation appliance comprises abutment means to limit the displacement of the supporting part 310 relative to the anchoring part 320, and FIGS. 4 to 6 represent three situations in which the food preparation appliance is loaded.

FIG. 4 represents the supporting leg in FIG. 3 when the food preparation appliance is lifted from the work surface. In this case, no force is applied to the supporting part 310, such the compression spring 331 is completely relaxed. To prevent the supporting part from coming too far out of the footwell 120, a radial shoulder of the anchor pin 322 abuts against a radial shoulder of the socket 313. Indeed, an upper surface 322e of the anchor pin 322 is in contact with a lower surface 313e of the socket 313.

It can be noted that the compression spring 331 contributes to laterally centering the supporting part 310 in the footwell 120, such that a lateral clearance is evenly distributed between the inner lateral face of the footwell 120 and the lateral face of the socket 313.

FIG. 5 represents the supporting leg in FIG. 3, when the food preparation appliance is resting on a work surface, under normal load conditions. In this case, the compression spring 331 is slightly compressed and a clearance is visible:
between the upper surface 322e of the anchor pin 322 and the lower surface 313e of the socket 313;
between an upper surface 312e of the strut 312 and the lower surface 120e of the footwell 120;
between a lateral surface of the spacer 312 and a lower lateral surface of the footwell 120.

As a result, all the weight applied to the food preparation appliance passes through the supporting leg 30, and in particular through the anchoring part 320. Consequently, the weighing bar 321 flexurally supports the entire weight and allows the weighing means to measure a force or variation of force applied to the housing in order to deduce therefrom the weight of the food received in the work bowl. Thus, the weighing bar 321 is mechanically connected in series with the supporting part 310 and with the leg attachment portion 110 of the housing 100.

FIG. 6 represents the supporting leg in FIG. 3, when the food preparation appliance is resting on the work surface, under excess load conditions. In this case, the compression spring 331 is compressed beyond a force predetermined by the stroke (e.g., a threshold force of 50 N) and
a clearance is visible between the upper surface 322e of the anchor pin 322 and the lower surface 313e of the socket 313;
no clearance is visible between the upper surface 312e of the strut 312 and the lower surface 120e of the footwell 120.

As a result, any force above the threshold force of 50 N does not pass through the supporting leg (and does not pass through the anchoring part 320 in particular), but through the footwell 120 which is in abutment with the supporting part 310. Thus, the abutment means are mechanically connected in parallel to the suspension means 300 of the supporting leg 30.

Consequently, the weighing bar 321 only supports the threshold force applied by the compression spring 331, the stroke of which is limited by the abutment of the footwell 120 with the supporting part 310. Overloading the weighing means 200 is avoided, because no excessive deformation of the weighing bar 321 is possible. Measurement precision is improved, as well as repeatability over time.

The situation of a lateral overload is not shown, but in the event that the user slides the food preparation appliance on the work surface, a lateral overload can be applied to the anchoring part 320 and in particular to the weighing bar 321. This situation is avoided by the assembly described, because the side wall of the socket 313 will abut with the inner side wall of the footwell 120, due to the elasticity of the compression spring 331. The lateral force will therefore be assumed by the housing 100 and does not pass through the weighing bar 321.

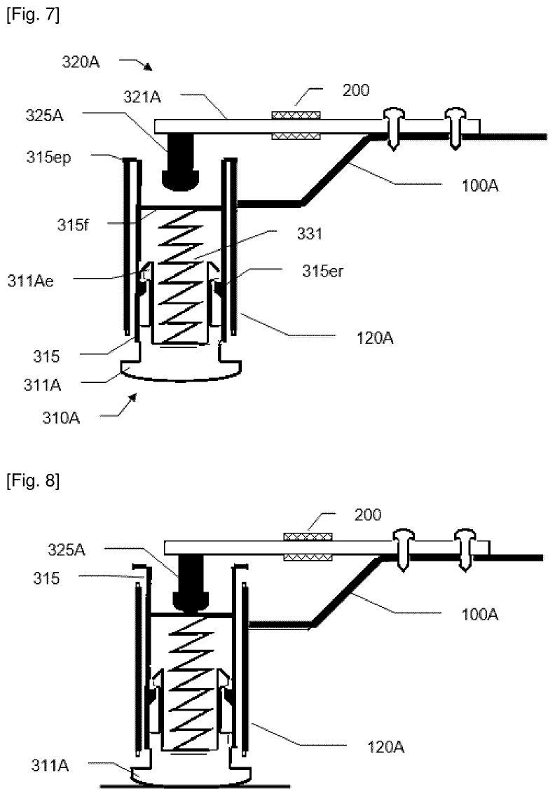

FIG. 7 represents a supporting leg according to an alternative embodiment of the embodiment of FIG. 3, when the food preparation appliance is lifted from the work surface.

According to this alternative embodiment, the housing 100A still comprises a footwell 120A. The suspension means comprise the anchoring part 320A, the compression spring 331 and the supporting part 310A. The supporting part 310A comprising a support pad 311A, and the compression spring 331 are mounted in a mobile socket 315, slidably mounted in the footwell 120A, and comprising a bottom 315f. The anchoring part 320A comprises a support pin 325A opposite the bottom 315f of the sliding socket 315.

When the food preparation appliance is lifted from the work surface as in FIG. 7, an upper shoulder 315ep of the sliding socket 315 abuts against the upper surface of the footwell 120A. Moreover, the lugs 311Ae of the support pad 311A are engaged with lugs 315er of the mobile socket 315 to prevent the support pad 311 from coming out of the mobile socket 315 under the action of the compression spring 331. No force passes into the weighing bar 321A such that the weighing means 200 are not loaded.

FIG. 8 is the alternative embodiment of FIG. 7, when the food preparation appliance is resting on a work surface under normal load conditions. In this case, the bottom 315f of the mobile socket 315 comes into contact with the support pin 325A and the compression spring 331 is slightly stressed and transmits all the forces to the weighing bar 321A. The weighing means can measure the weight applied to the appliance.

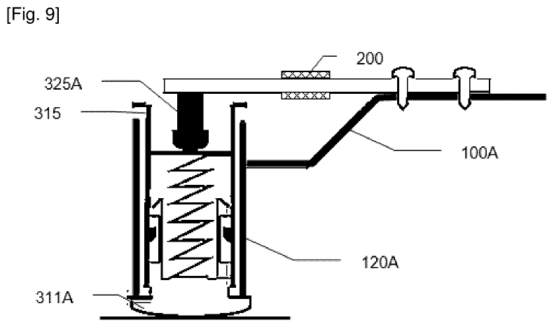

FIG. 9 is the alternative embodiment of FIG. 7, when the food preparation appliance is resting on the work surface, under excessive load conditions. In this case, the lower face of the footwell 120A abuts with a ring on the upper face of the support pad 311A, such that the overload causing this abutment passes through the housing 100A and not through the anchoring part 320A of the suspension means. Thus, the weighing bar 321A and the weighing means 200 do not undergo any excessive deformation.

To summarize, in both embodiments, the abutment means (the lower surface of the footwell and/or the inner lateral surface of the footwell) make it possible to guarantee that no overload exceeding the spring compression threshold force will be applied to the weighing means. The threshold force is the force applied by the spring at its maximum compression allowed by the abutment means.

### INDUSTRIAL APPLICATION

A food preparation appliance according to the present invention, and the manufacture thereof, are suitable for industrial application.

It will be understood that various modifications and/or improvements that are obvious for the person skilled in the art may be made to the different embodiments of the invention described in this description without departing from the scope of the invention.

In particular, it can be noted that the housing or a portion of the anchoring part may very well be designed to abut with the work surface and not with the supporting part.

Moreover, in the first embodiment, the socket 313 could have an upper shoulder that extends radially outward to engage with the upper portion of the footwell 120.

The elastic return means may be provided in the form of a compression spring, or a spring blade, or a gas spring, etc.

With regard to weighing means, any other strain sensor or other form can be provided for the weighing bar.

1. A food preparation appliance comprising:
a housing including at least one supporting leg configured to rest on a work surface, the at least one supporting leg including a suspension means comprising a supporting part configured to be positioned on the work surface, an anchoring part connected to a portion attaching the leg of the housing, and an elastic return means connecting the supporting part to the anchoring part such that the supporting part can move relative to the anchoring part;
a work bowl configured to receive food to be prepared;
weighing means configured to weigh the food to be prepared;
an abutment means configured to limit movement of the supporting part relative to the anchoring part, wherein
the weighing means is positioned between the supporting part and the portion attaching the leg of the housing.

2. The food preparation appliance according to claim 1, wherein the supporting part is configured to move in an axial direction relative to the anchoring part, the axial direction being substantially perpendicular to the work surface, and wherein the abutment means is configured to limit axial displacement of the supporting part relative to the anchoring part beyond a predetermined first force.

3. The food preparation appliance according to claim 2, wherein the abutment means includes an abutment part integral with at least one of the housing and the anchoring part, the abutment part configured to abut a portion of the supporting part in order to limit axial displacement of the supporting part relative to the anchoring part.

4. The food preparation appliance according to claim 3, wherein the portion of the supporting part forms a peripheral flange defining a contour of the supporting part configured to contact the abutment part.

5. The food preparation appliance according to claim 2, wherein the abutment means includes an abutment part integral with at least one of the housing and the anchoring part, the abutment configured to abut the work surface to limit axial displacement of the supporting part relative to the anchoring part.

6. The food preparation appliance according to claim 2, wherein:
at least one of the housing and the anchoring part includes a footwell forming at least a partial casing for the supporting leg and a lower end contour forming the abutment means.

7. The food preparation appliance according to claim 2, further comprising a secondary axial abutment means including:
a secondary leg abutment integral with the supporting part,
a secondary housing abutment integral with the housing,
the secondary leg abutment configured to abut the secondary housing abutment to limit axial displacement of the supporting part below a second predetermined force.

8. The food preparation appliance according to claim 7, wherein the secondary leg abutment comprises a shoulder configured to contact a shoulder of the secondary housing abutment.

9. The food preparation appliance according to claim 8, wherein the suspension means is configured to allow lateral displacement of the supporting part relative to the anchoring part in a direction lateral or tangential to the work surface, and wherein the abutment means includes a lateral abutment means positioned between the supporting leg and the housing and configured to limit lateral displacement of the supporting part relative to the anchoring part.

10. The food preparation appliance according to claim 9, wherein the lateral abutment means is positioned on a side wall of the footwell of the housing or of the anchoring part, the supporting part configured to abut the side wall of the footwell to limit lateral displacement of the supporting part relative to the anchoring part.

11. The food preparation appliance according to claim 1, wherein the elastic return means includes a compression spring configured to exert a predetermined suspension force to push the supporting part of the anchoring part in a direction normal to the work surface.

12. The food preparation appliance according to claim 11, wherein the anchoring part includes an axial housing for receiving the compression spring, and for positioning an upper part of the supporting part, to cause a neutral position or equilibrium position of the supporting part relative to the anchoring part in at least one direction lateral or tangential to the work surface.

13. The food preparation appliance according to claim 11, wherein the compression spring is positioned between the weighing means and the supporting part.

14. The food preparation appliance according to claim 1, wherein the anchoring part includes at least one weighing bar configured to deform when a load is applied to the housing or the work bowl.

15. The food preparation appliance according to claim 14, wherein the weighing bar is attached to the portion attaching the leg of the housing.

16. The food preparation appliance according to claim 1, wherein the weighing means comprise at least one of a strain gauge, a strain sensor, and a piezoelectric sensor.

17. The food preparation appliance according to claim 1, further comprising a working means comprising at least one work tool having a drive motor configured to move the work tool in the work bowl, and a cooking means configured to heat the food to be prepared.
